(19) United States
(12) Patent Application Publication
(10) Pub. No.: US 2018/0101074 A1
(43) Pub. Date: Apr. 12, 2018

(54) CURVED DISPLAY PANEL AND MANUFACTURING METHOD FOR THE SAME

(71) Applicant: Shenzhen China Star Optoelectronics Technology Co., Ltd., Shenzhen, Guangdong (CN)

(72) Inventors: Kecheng XIE, Shenzhen, Guangdong (CN); Ri HONG, Shenzhen, Guangdong (CN)

(73) Assignee: Shenzhen China Star Optoelectronics Technology Co., Ltd., Shenzhen, Guangdong (CN)

(21) Appl. No.: 15/102,609

(22) PCT Filed: May 19, 2016
(86) PCT No.: PCT/CN2016/082599

§ 371 Date: Jun. 8, 2016

(30) Foreign Application Priority Data
Mar. 7, 2016 (CN) 201610127633.8

(51) Int. Cl. G02F 1/1362; G02F 1/1335; G02F 1/1339

(52) U.S. Cl. CPC G02F 1/136209; G02F 2001/13356; G02F 1/13392; G02F 1/133516

(57) ABSTRACT

A curved display panel and a manufacturing method. The method includes: providing a first substrate; forming a color resist layer on the first substrate, and forming a recessed region at a preset position of the color resist layer such; providing a second substrate; forming a spacer on the second substrate; and aligning, assembling and adhering the first substrate and the second substrate such that the spacer is embedded inside the recessed region. The present invention also provides a curved display panel. Through above way, the spacer of the curved display panel is embedded inside the recessed region such that when the curved display panel is bent, the spacer will not generate a displacement so as to reduce the light leakage phenomenon, decrease the yield rate loss of the display panel.

### BACKGROUND OF THE INVENTION

### 1. Field of the Invention

The present invention relates to a display panel field, and more particularly to a curved display panel and a manufacturing method for the same.

### 2. Description of Related Art

A curved display device can provide a deeper viewing experience for users because of better contrast ratio, wider viewing angle and immersive experience. In the application of the curved display device, because the panel exists a certain bending such that a misalignment will be generated between two substrates which form the panel such that a light shielding effect of a black matrix on one substrate will be affected so as to generate a light leakage phenomenon after bending. Specifically, with reference to FIG. 1 and FIG. 2, wherein, FIG. 1 is a light shielding situation of the black matrix 12 when the panel 11 is not bent. FIG. 2 is the light shielding situation of the black matrix 12 when the panel 11 is bent. It shows that when the panel 11 is bent in FIG. 2, the spacer 13 on the panel 11 will generate a displacement to cause a light leakage phenomenon. The solution in the traditional VA mode is to increase a light shielding layer of the black matrix. However, the method will sacrifice 20% transmissivity so as to greatly decrease the property of the product.

### SUMMARY OF THE INVENTION

The technology problem mainly solved by the present invention is to provide a curved display panel and manufacturing method for the same, which can improve the light leakage phenomenon of the product after bending without sacrificing the transmissivity of the product.

In order to solve the above technology problem, a technology solution adopted by the present invention is: providing a manufacturing method for a curved display panel, comprising following steps: providing a first substrate; forming a switching tube on the first substrate; forming a color resist layer on the first substrate, wherein, the color resist layer covers the switching tube, and forming a recessed region at a location of the color resist layer corresponding to the switching tube; providing a second substrate; forming a black matrix on the second substrate; forming a spacer on the black matrix; and aligning, assembling and adhering the first substrate and the second substrate such that the spacer is embedded inside the recessed region.

In order to solve the above technology problem, another technology solution adopted by the present invention is: providing a manufacturing method for a curved display panel, comprising following steps: providing a first substrate; forming a color resist layer on the first substrate, and forming a recessed region at a preset position of the color resist layer; providing a second substrate; forming a spacer on the second substrate; and aligning, assembling and adhering the first substrate and the second substrate such that the spacer is embedded inside the recessed region.

Wherein, before the step of forming a color resist layer on the first substrate, and forming a recessed region at a preset position of the color resist layer, further comprises a step of: forming a switching tube on the first substrate; wherein, the color resist layer covers the switching tube, and the preset position is a location of the color resist layer corresponding to the switching tube.

Wherein, the first substrate is an array substrate, and the switching tube is a thin-film transistor.

Wherein, before the step of forming a spacer on the second substrate, further comprises: forming a black matrix on the second substrate; wherein, the spacer is formed on the black matrix.

Wherein, the second substrate is a color filter substrate.

Wherein, the recessed region is formed through a half-tone method to perform a partial exposure at the preset position of the color resist layer.

Wherein, a size of the recessed region in a range of 1 um-100 um, and a depth of the recessed region in a range of 1/10-¾ of a thickness of the color resist layer.

Wherein, the step of forming a color resist layer on the first substrate, and forming a recessed region at a preset position of the color resist layer comprises step of: forming a color resist layer on the first substrate; forming a passivation layer on the color resist layer; and forming a recessed region at preset positions of the color resist layer and the passivation layer such that the color resist layer at a location of the recessed region is revealed through the passivation layer.

Wherein, in the step of forming a recessed region at preset positions of the color resist layer and the passivation layer comprises step of: adopting a dry etching method to clear the passivation layer at the preset position; and adopting oxygen or inert gas to remove the color resist layer at the preset position in order to form the recessed region.

Wherein, after the step of forming a color resist layer on the first substrate, and forming a recessed region at a preset position of the color resist layer, further comprises a step of: forming a passivation layer on the color resist layer such that the passivation layer integrally covers the color resist layer.

In order to solve the above technology problem, another technology solution adopted by the present invention is: providing a curved display panel, comprising: a first substrate; a color resist layer disposed on the first substrate, and provided with a recessed region at a preset position; a second substrate; and a spacer disposed on the second substrate, and the spacer is embedded inside the recessed region.

Wherein, the curved display panel further includes: a switching tube disposed on the first substrate, wherein, the color resist layer covers the switching tube, the preset position is a location of the color resist layer corresponding to the switching tube; and a black matrix disposed on the second substrate, wherein, the spacer is disposed on the black matrix.

Wherein, the curved display panel further includes a passivation layer, and the passivation layer is disposed on and integrally covers the color resist layer.

Wherein, the curved display panel further includes a passivation layer, the passivation layer is disposed on the color resist layer, and the color resist layer at the recessed region is revealed through the passivation layer.

Wherein, a portion of the passivation layer at the recessed region is cleared through a dry etching method; a portion of the color resist layer at the recessed region is removed through oxygen or inert gas in order to form the recessed region.

Wherein, the recessed region is formed through a half-tone method to perform a partial exposure at the preset position of the color resist layer.

The beneficial effects of the present invention is: comparing to the conventional art, the present invention provides a first substrate, forming a color resist layer on the first substrate and forming a recessed region at a preset position of the color resist layer. At the time, providing a spacer on a second substrate, aligning, assembling and adhering the first substrate and the second substrate such that the spacer is embedded inside the recessed region. Through above way, the spacer of the curved display panel is embedded inside the recessed region such that when the curved display panel is bent, the spacer will not generate a displacement so as to reduce the light leakage phenomenon, decrease the yield rate loss of the display panel.

### BRIEF DESCRIPTION OF THE DRAWINGS

FIG. 1 is a schematic diagram of a curved display panel of the conventional art;

FIG. 2 is a schematic diagram of a curved display panel after bending of the conventional art;

FIG. 3 is a flow chart of a manufacturing method for a curved display panel of a first embodiment of the present invention;

FIG. 4a˜FIG. 4c are cross-sectional views of the curved display panel in all steps of the first embodiment of the present invention;

FIG. 5 is a flow chart of a second embodiment of a curved display panel of the present invention;

FIG. 6a˜FIG. 6e are cross-sectional views of the curved display panel in all steps of the second embodiment of the present invention;

FIG. 7 is a flow chart of a third embodiment of a curved display panel of the present invention;

FIG. 8a˜FIG. 8d are cross-sectional views of the curved display panel in all steps of the third embodiment of the present invention;

FIG. 9 is a schematic diagram of a curved display panel of a first embodiment of the present invention; and

FIG. 10 is a schematic diagram of a curved display panel of a second embodiment of the present invention.

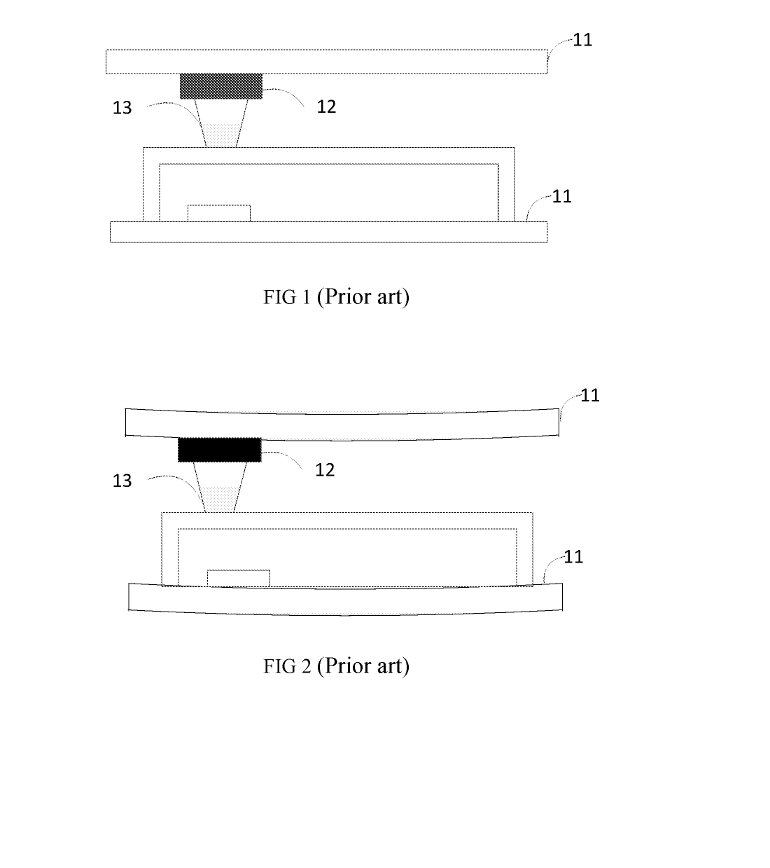

### DETAILED DESCRIPTION OF THE PREFERRED EMBODIMENT

In order to make the person skilled in the art to understand the technology solution of the present invention better, the following will combine the figures and specific embodiments to describe a curved display panel and manufacturing method for the same in detail.

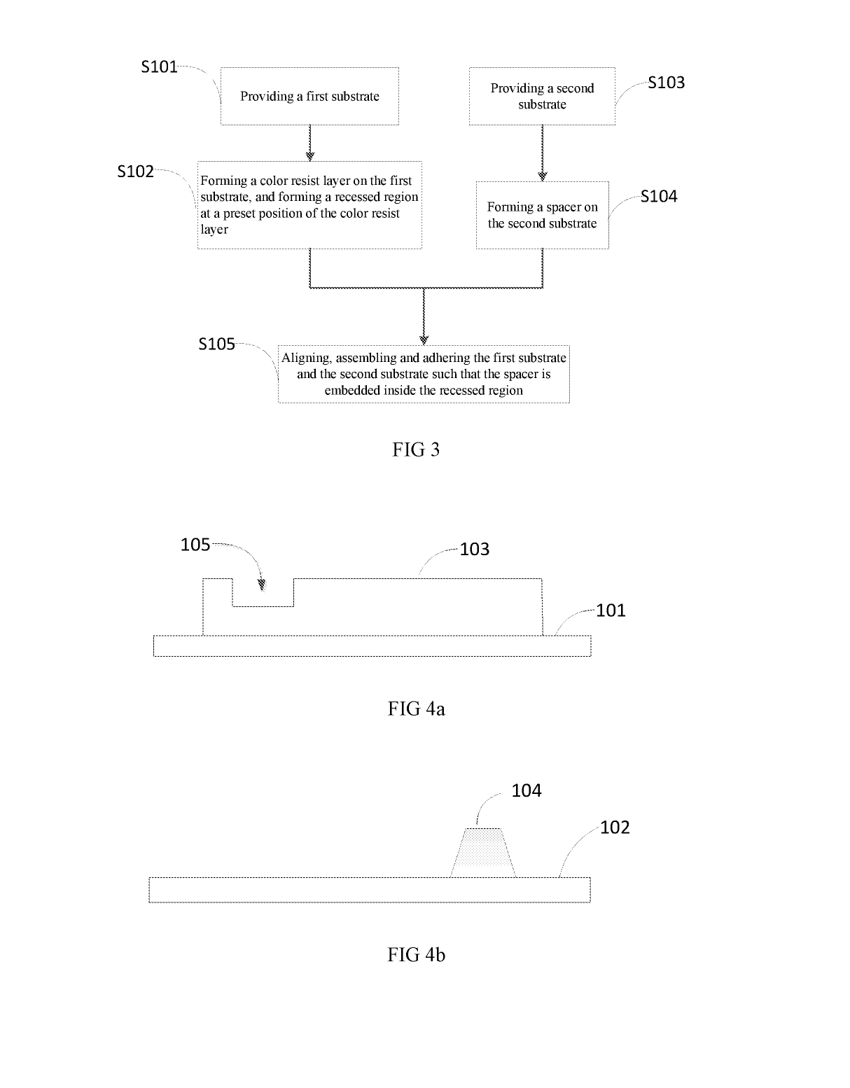

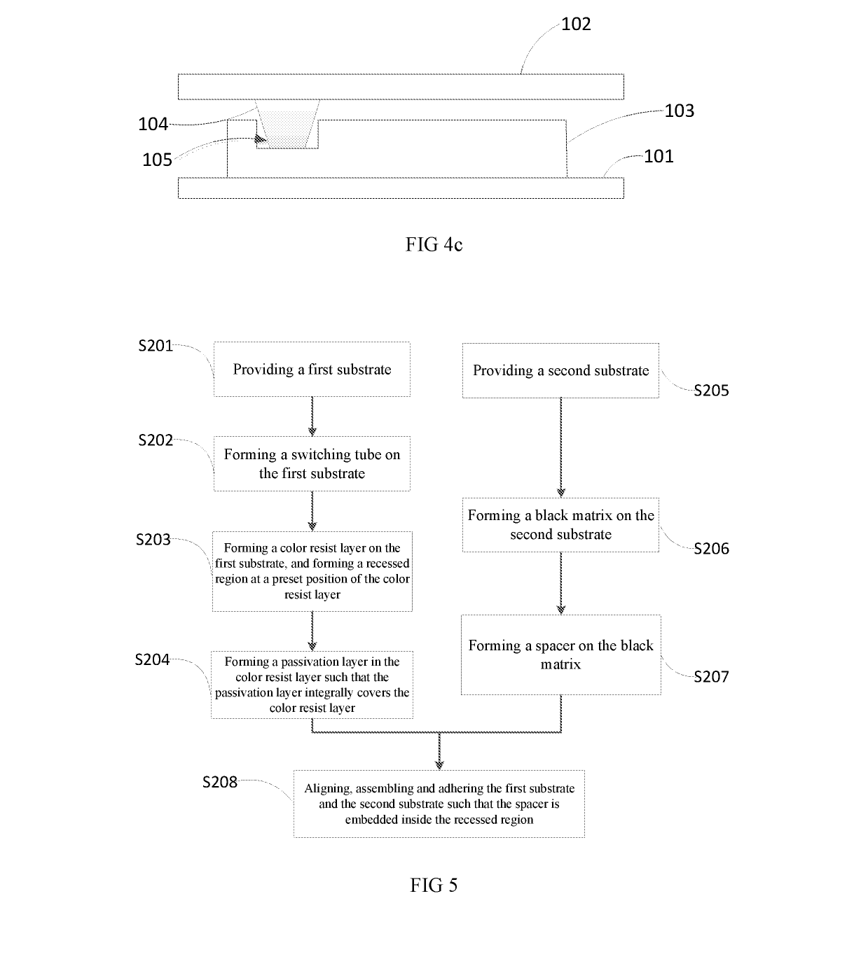

FIG. 3 is a flow chart of a manufacturing method of a curved display panel of a first embodiment of the present invention, FIG. 4a˜FIG. 4c are cross-sectional views of the curved display panel in all steps of the first embodiment of the present invention. As shown in FIG. 3 and FIG. 4, the manufacturing method for the curved display panel specifically includes following steps:

S101: providing a first substrate 101;

S102: forming a color resist layer 103 on the first substrate 101, and forming a recessed region 105 at a preset position of the color resist layer 103;

Specifically, as shown in FIG. 4a, which is a schematic diagram of a first substrate manufactured through the step S101 and the step S102. Through a half-tone method to perform a partial exposure in order to form the recessed region 105 at the preset position of the color resist layer 103. In the exposure process, the cumulative amount of light of the color resist layer is different so that after developing, the thicknesses at of the color resist layer are also different. Therefore, the size of the recessed region 105 depends on the requirement of the product design, and can select in a range of 1 um-100 um. The depth of the recessed region 105 also depends on the requirement of the product design, and can select in a range of 1/10 to ¾ of a thickness of the color resist layer.

The preset position is usually a position that can block a light to prevent a light leakage phenomenon. The number of the preset position and the number of the recessed region 105 are not limited, and can be based on matching the number of spacer described following.

S103: providing a second substrate 102;

S104: forming a spacer 104 on the second substrate 102;

Specifically, as shown in FIG. 4b, which is a schematic diagram of the second substrate manufactured through the step S103 and the step S104. The spacer 104 is formed on the second substrate 102 corresponding to the recessed region 105 on the first substrate 101. The spacer 104 can reserve a space between the first substrate 101 and the second substrate 102 in order to fill liquid crystals, and support the first substrate 101 and the second substrate 102. Therefore, the spacer 104 is evenly distributed on the second substrate 102 such that the thickness of the filled liquid crystals is uniform. The material and the shape of the spacer 104 will affect the response speed, contrast ratio, viewing angle and so on. Usually, a columnar spacer 104 is selected as shown in FIG. 4b.

The spacer 104 is used for controlling a gap between two substrates in order to maintain the thickness of the liquid crystals. In a usage process, a displacement of the spacer 104 will generate a cavity such that a light leakage phenomenon of the display panel is generated.

It should be noted that the step S103 and the step 104 are not performed after the step S102, the manufacturing of the two substrates can be performed simultaneously or not, and the sequence is not limited.

Step S105, aligning, assembling and adhering the first substrate 101 and the second substrate 102 such that the spacer 104 is embedded inside the recessed region 105.

Specifically, as shown in FIG. 4c, which is a schematic diagram of the first substrate 101 and the second substrate 102 after aligning, assembling and adhering. The spacer 104 on the second substrate 102 is right embedded inside the recessed region 105 of the first substrate 101 such that when the curved display panel is bent, because the spacer 104 is fixed without generating a displacement in order to reduce the light leakage phenomenon.

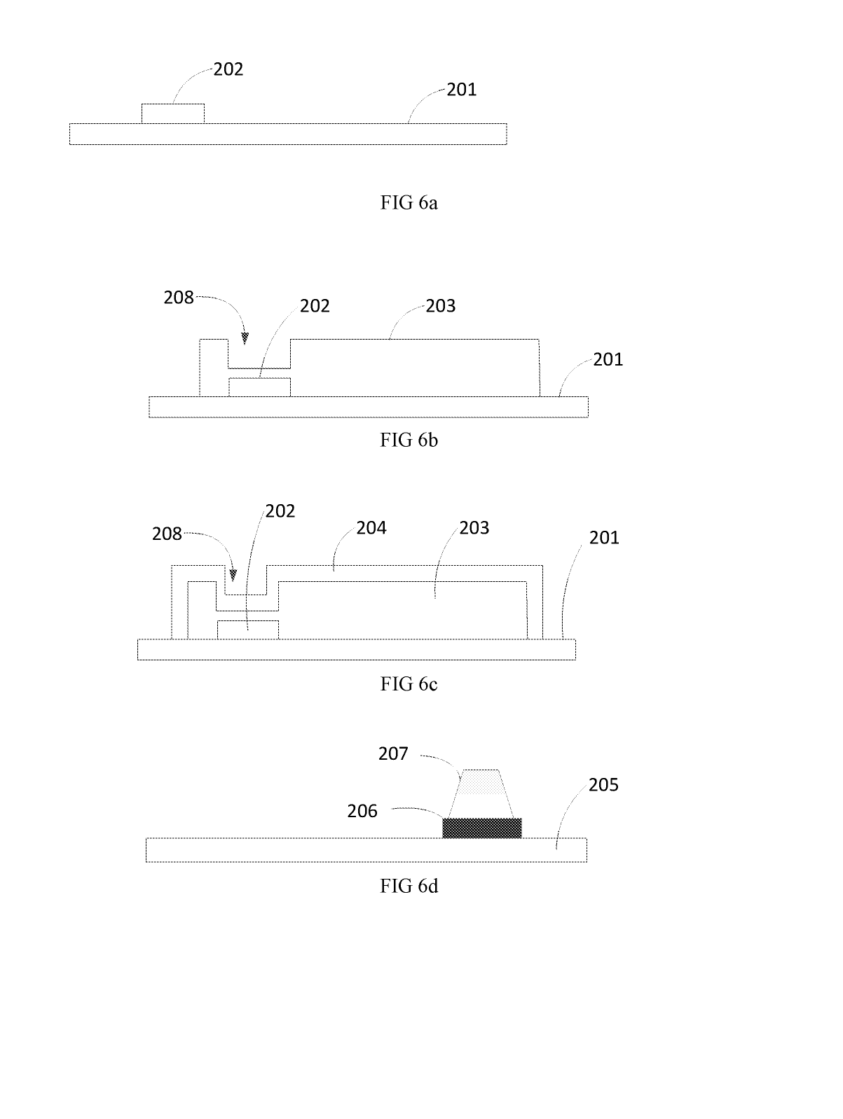

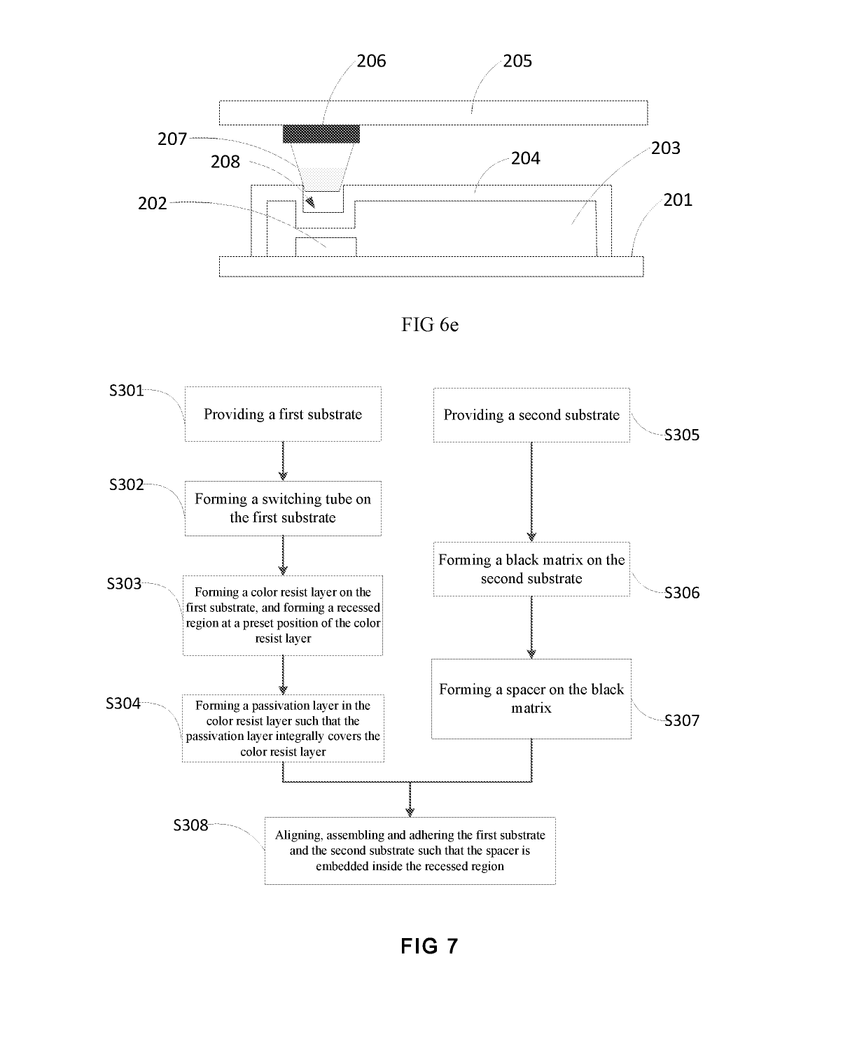

FIG. 5 is a flow chart of a second embodiment of a curved display panel of the present invention; FIG. 6a˜FIG. 6e are cross-sectional views of the curved display panel in all steps of the second embodiment of the present invention. Wherein, the first substrate 201 adopts an array substrate, and the second substrate 205 adopts a color filter substrate. As shown in FIG. 5 and FIG. 6, the manufacturing method for the curved display panel specifically includes following steps:

S201: providing a first substrate 201;

S202: forming a switching tube 202 on the first substrate 201;

Specifically, as shown in FIG. 6a, which is a schematic diagram of the switching tube 202 manufactured through the step S201 and the step S202. Forming the switching tube 202 on the first substrate 201, that is, the array substrate 201, and the switching tube 202 can select as a thin-film transistor TFT. First, forming the TFT 202 on the array substrate 201. The process can adopts any one of the processes in the conventional art such as forming a gate electrode on the array substrate 201 at the first, then, sequentially forming a first insulation layer and an active layer on the gate electrode layer, forming a source electrode and a drain electrode on the active layer. Finally, forming a second insulation layer on the drain electrode. Accordingly, the TFT 202 is formed.

S203: forming a color resist layer 203 on the first substrate 201, and forming a recessed region 208 at a preset position of the color resist layer 203. Wherein, the color resist layer 203 covers the switching tube 202. The preset position is a location of the color resist layer 203 that is corresponding to the switching tube 202.

Specifically, as shown in FIG. 6b, which is a schematic diagram of a color resist layer 203 manufactured through the step S203. After forming the TFT 202, coating the color resist layer 203 on the TFT 202, and the color resist layer covers the TFT 202. Then, using a half-tone method to manufacture a recessed region 208 at the preset position of the color resist layer 203 corresponding to TFT 202. In the exposure process, the cumulative amount of light of the color resist is different so that after developing, the thickness of the color resist is also different. Therefore, the size of the recessed region 208 depends on the requirement of the product design, and can select in a range of 1 um-100 um. The depth of the recessed region 208 also depends on the requirement of the product design, and can select in a range of 1/10 to ¾ of the thickness of the color resist layer.

S204, forming a passivation layer 204 in the color resist layer 203 such that the passivation layer 204 integrally covers the color resist layer 203.

Specifically, as shown in FIG. 6c, which is a schematic diagram of the passivation layer 204 manufactured through the step S204. Because the passivation layer 204 covers the color resist layer 203, a location of the passivation layer 204 corresponding to the TFT 202 is also provided with a recessed region 208. Further forming an ITO transparent conductive layer on the passivation layer 204 in order to finish the manufacturing of the array substrate 201.

S205: providing a second substrate 205;

S206: forming a black matrix 206 on the second substrate 205;

S207: forming a spacer 207 on the black matrix 206;

Specifically, as shown in FIG. 6d, which is a schematic diagram of the second substrate 205 manufacturing through the step S205 to the step S207.

On the second substrate 205, that is, the color filter substrate 205, a black matrix 206 is formed. The black matrix 206 can be finished through processes of exposing, developing, stripping and so on. Before forming the spacer 207 on the black matrix 206, an ITO transparent conductive layer can be formed on the black matrix 206. Then, forming the spacer 207 on the ITO transparent conducive layer in order to finish the manufacturing of the color filter substrate 205.

Wherein, the location where the black matrix 206 is formed is corresponding to the location of TFT 202, and this is a consideration of the function of the black matrix 206. The black matrix 206 has following three functions: first, blocking and absorbing an incident light from outside in order to avoid the incident light directly or indirectly irradiates on the a-Si layer of the channel region of the TFT device through reflection and scattering such that an off-state property of the TFT device is deteriorated; second, the black matrix 206 can block the light leakage generated at the gap between the TFT electrode lead on the array substrate 201 and the ITO pixel electrode such that the contrast ratio of an image is decreased. Third, avoid that an alignment defect of reverse tilt at a pixel edge when a liquid crystal cell is under a transverse electric field so that the contrast ratio is decreased and the afterimage phenomenon is generated. The spacer 207 is formed on the black matrix 206, when the spacer 207 generates a displacement, the black matrix 206 and the TFT will generate a misalignment so a s to affect the blocking effect in order to generate a light leakage phenomenon.

S208, aligning, assembling and adhering the first substrate 201 and the second substrate 205 such that the spacer 207 is embedded inside the recessed region 208.

As shown in FIG. 6e, aligning, assembling and adhering the array substrate 201 and the color filter substrate 205 after being manufactured in order to form a flat display panel. Bending the flat display panel in order to form a curved display panel. The spacer 207 on the color filter substrate 205 is right embedded into the recessed region 208 formed on the array substrate such that when bending the flat display panel, because the spacer 207 is fixed without generating a displacement so that a friction of the spacer 207 to a contact layer such as PI film on the array substrate 201 is decreased in order to reduce the light leakage phenomenon.

It should be noted that the manufacturing processes of the array substrate 201 and the color filter substrate 205 can be performed simultaneously or not, and the sequence is not limited. In another embodiment, the first substrate 201 can adopt a color filter substrate, and the second substrate 205 can adopt an array substrate.

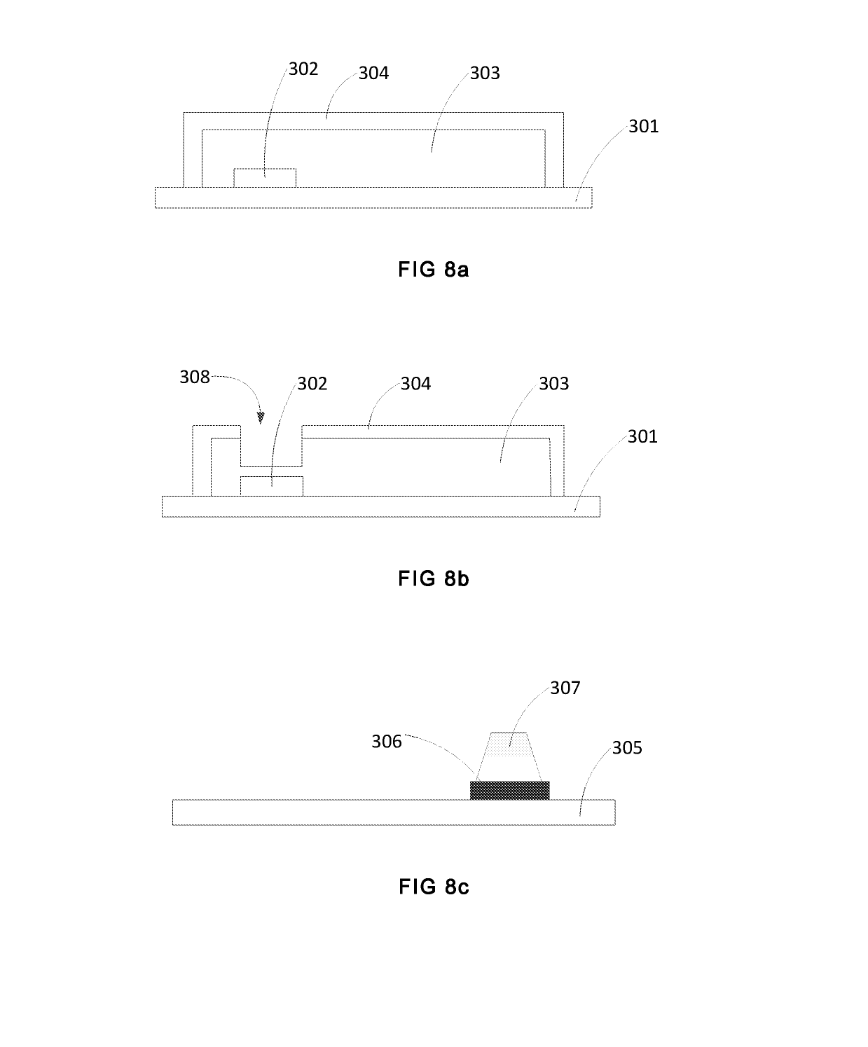

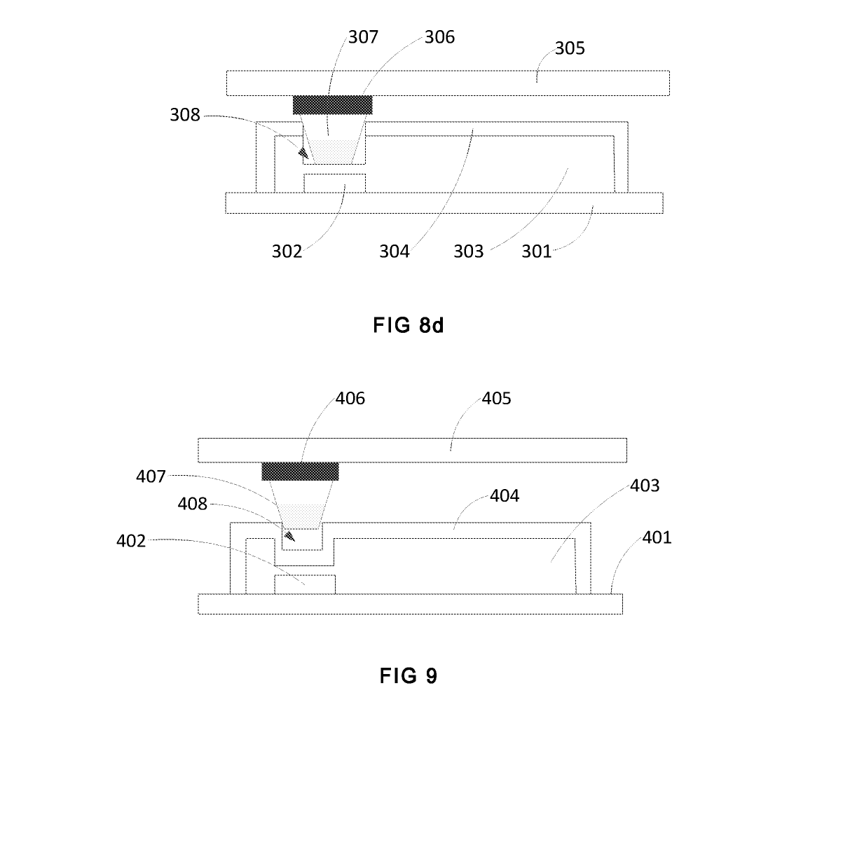

FIG. 7 is a flow chart of a third embodiment of a curved display panel of the present invention; FIG. 8a˜FIG. 8d are cross-sectional views of the curved display panel in all steps of the third embodiment of the present invention. As shown in FIG. 7 and FIG. 8, the manufacturing method for the curved display panel specifically includes following steps:

S301: providing a substrate;

S302: forming a switching tube 302 on the substrate;

S303: forming a color resist layer 303 on the substrate;

S304: forming a passivation layer 304 on the color resist layer 303;

As shown in FIG. 8a, which is a schematic diagram of the first substrate 301 formed after performing the step S301 to the step S304. The process of forming the switching tube 302 is similar to the step S201 and the step S202 of the above second embodiment, no more repeating. Coating a color resist layer 303 on the switching tube 302 and depositing the passivation layer 304 on the color resist layer 303.

S305: forming a recessed region 308 at preset positions of the color resist layer 303 and the passivation layer 304 such that the color resist layer 303 at a location of the recessed region 308 is revealed through the passivation layer 304.

As shown in FIG. 8b, which is a schematic diagram of the recessed region 308 formed after executing the step S304. Adopting a half-tone method to perform the manufacturing for the recessed region 308, adopting a dry etching method to clear the preset position, that is, a location of the passivation layer 304 corresponding to the switching tube 302, and adopting oxygen or inert gas to remove the color resist layer at the recessed region 308, the color resist layer in the recessed region 308 is revealed through the passivation layer 304.

Performing the manufacturing of the ITO transparent conductive layer and PI film on the passivation layer 304. In the above process, because the location of the color resist layer 303 corresponding to the recessed region 308 is not covered with the passivation layer 304, the color resist will undergo the function of the high temperature, the organic material inside the color resist will be discharged from the recessed region 308, which greatly help for improving the liquid crystal bubbles and afterimage phenomenon.

S306: providing a second substrate 305;

S307: forming a black matrix 306 on the second substrate 305;

S308: forming a spacer 307 on the black matrix 306;

Specifically, with reference to FIG. 8c, the manufacturing processes of the step S306 to the step S308 are similar to the processes of the step S205 to the step S207 in the second embodiment, no more repeating.

S309: aligning, assembling and adhering the first substrate 301 and the second substrate 305 such that the spacer 307 is embedded inside the recessed region 308.

With reference to FIG. 8d, after the first substrate 301 and the second substrate 305 are aligned, assembling and adhered, the spacer 307 on the second substrate 305 is right embedded inside the recessed region 308 of the first substrate 301, the spacer 307 is directly contacted with the color resist of the color resist layer inside the recessed region 308. Generally, the both include organic materials. A binding force of an organic material to another organic material is relative high such that when the curved display panel is bent, comparing to the second embodiment of the present invention, a displacement is more difficult to generate in order to greatly reduce the light leakage phenomenon.

The present invention describe a manufacturing method for a curved display panel in detail through three embodiments, through aligning, assembling and adhering the first substrate 301 and the second substrate 305 such that the spacer 307 on the second substrate 305 is right embedded inside the recessed region 308 of the color resist layer 303 on the first substrate 301. Accordingly, when the curved display panel is bent, the spacer 307 is fixed without generating a displacement in order to reduce the light leakage phenomenon.

With reference to FIG. 9, which is a first embodiment of a curved display panel of the present invention, including:

a first substrate 401;

a switching tube 402 disposed on the first substrate 401;

a color resist layer 403 disposed on the first substrate 401 and covering the switching tube 402, and the color resist layer 403 is provided with a recessed region 408 at a location corresponding to the switching tube 402;

a passivation layer 404 disposed on and integrally covering the color resist layer 403;

a second substrate 405;

a black matrix 406 disposed on the second substrate 405;

a spacer 407 disposed on the black matrix 406, and the spacer 407 is embedded inside the recessed region 408.

In the curved display panel of the first embodiment, the spacer 407 of the second substrate 405 is right embedded inside the recessed region 408 of the first substrate 401 such that when the display panel is bent, the spacer 407 is fixed by the recessed region 408 without generating a displacement in order to reduce a light leakage phenomenon and decrease the yield loss of the display panel.

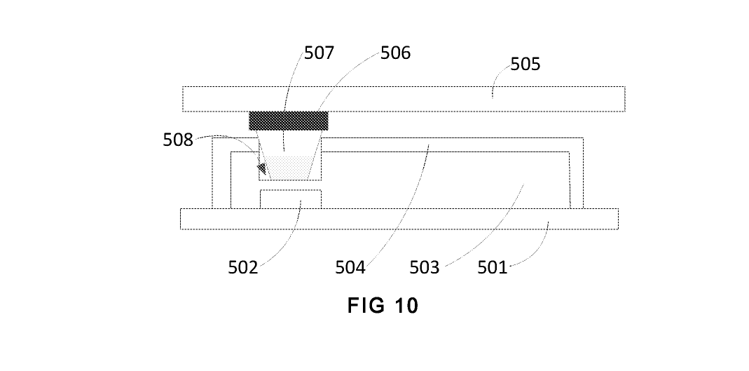

As shown in FIG. 10, the second embodiment of the curved display panel of the present invention, including:

a first substrate 501;

a switching tube 502 disposed on the first substrate 501;

a color resist layer 503 disposed on the first substrate 501 and covering the switching tube 502, and the color resist layer 503 is provided with a recessed region 508 at a location corresponding to the switching tube 502;

a passivation layer 504 disposed on the color resist layer 503, and the color resist layer 504 at the location of the recessed region 508 is revealed through the passivation layer 504;

a second substrate 505;

a black matrix 506 disposed on the second substrate 505; and

a spacer 507 disposed on the black matrix 506, and the spacer 507 is embedded inside the recessed region 508.

The curved display panel of the second embodiment, because the spacer 507 on the second substrate 505 is embedded inside the recessed region 508 of the first substrate 501, the binding force of the organic materials is higher. When the display panel is bent, because the spacer 507 is fixed without generating a displacement, the corresponding black matrix 506 also cannot generate a misalignment, and the spacer 507 and a surface contacted with the spacer 507 can avoid a friction because of the displacement so that the light leakage phenomenon after the display panel is bent is greatly improved. At the same time, because on the recessed region 508, no passivation layer 504 is provided for blocking, the foreign material of the color resist will be volatilized in following processes such as ITO process, PI process and so on, which will greatly reduce the pollution of the liquid crystals by the foreign material of the color resist after aligning, assembling and adhering, increase the yield rate of the curved display panel and decrease the loss.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A manufacturing method for a curved display panel, comprising following steps:
providing a first substrate;
forming a switching tube on the first substrate;
forming a color resist layer on the first substrate, wherein, the color resist layer covers the switching tube, and forming a recessed region at a location of the color resist layer corresponding to the switching tube;
providing a second substrate;
forming a black matrix on the second substrate;
forming a spacer on the black matrix; and
aligning, assembling and adhering the first substrate and the second substrate such that the spacer is embedded inside the recessed region.

2. A manufacturing method for a curved display panel, comprising following steps:
providing a first substrate;
forming a color resist layer on the first substrate, and forming a recessed region at a preset position of the color resist layer;
providing a second substrate;
forming a spacer on the second substrate; and
aligning, assembling and adhering the first substrate and the second substrate such that the spacer is embedded inside the recessed region.

3. The method according to claim 2, wherein, before the step of forming a color resist layer on the first substrate, and forming a recessed region at a preset position of the color resist layer, further comprises a step of:
forming a switching tube on the first substrate;
wherein, the color resist layer covers the switching tube, and the preset position is a location of the color resist layer corresponding to the switching tube.

4. The method according to claim 3, wherein, the first substrate is an array substrate, and the switching tube is a thin-film transistor.

5. The method according to claim 2, wherein, before the step of forming a spacer on the second substrate, further comprises:
forming a black matrix on the second substrate;
wherein, the spacer is formed on the black matrix.

6. The method according to claim 5, wherein, the second substrate is a color filter substrate.

7. The method according to claim 2, wherein, the recessed region is formed through a half-tone method to perform a partial exposure at the preset position of the color resist layer.

8. The method according to claim 7, wherein, a size of the recessed region in a range of 1 um-100 um, and a depth of the recessed region in a range of 1/10-¾ of a thickness of the color resist layer.

9. The method according to claim 2, wherein, the step of forming a color resist layer on the first substrate, and forming a recessed region at a preset position of the color resist layer comprises step of:
forming a color resist layer on the first substrate;
forming a passivation layer on the color resist layer; and
forming a recessed region at preset positions of the color resist layer and the passivation layer such that the color resist layer at a location of the recessed region is revealed through the passivation layer.

10. The method according to claim 9, wherein, in the step of forming a recessed region at preset positions of the color resist layer and the passivation layer comprises step of:
adopting a dry etching method to clear the passivation layer at the preset position; and
adopting oxygen or inert gas to remove the color resist layer at the preset position in order to form the recessed region.

11. The method according to claim 2, wherein, after the step of forming a color resist layer on the first substrate, and forming a recessed region at a preset position of the color resist layer, further comprises a step of:
forming a passivation layer on the color resist layer such that the passivation layer integrally covers the color resist layer.

12. A curved display panel, comprising:
a first substrate;
a color resist layer disposed on the first substrate, and provided with a recessed region at a preset position;
a second substrate; and
a spacer disposed on the second substrate, and the spacer is embedded inside the recessed region.

13. The curved display panel according to claim 12, wherein, the curved display panel further includes:
a switching tube disposed on the first substrate, wherein, the color resist layer covers the switching tube, the preset position is a location of the color resist layer corresponding to the switching tube; and
a black matrix disposed on the second substrate, wherein, the spacer is disposed on the black matrix.

14. The curved display panel according to claim 13, wherein, the curved display panel further includes a passivation layer, and the passivation layer is disposed on and integrally covers the color resist layer.

15. The curved display panel according to claim 13, wherein, the curved display panel further includes a passivation layer, the passivation layer is disposed on the color resist layer, and the color resist layer at the recessed region is revealed through the passivation layer.

16. The curved display panel according to claim 15, wherein, a portion of the passivation layer at the recessed region is cleared through a dry etching method;
a portion of the color resist layer at the recessed region is removed through oxygen or inert gas in order to form the recessed region.

17. The curved display panel according to claim 12, wherein, the recessed region is formed through a half-tone method to perform a partial exposure at the preset position of the color resist layer.
